(19) United States
(12) Patent Application Publication
(10) Pub. No.: US 2022/0327594 A1
(43) Pub. Date: Oct. 13, 2022

(54) SYSTEMS AND METHODS FOR USEFUL LIFE DETERMINATION OF TARGET ITEMS

(71) Applicant: Capital One Services, LLC, McLean, VA (US)

(72) Inventors: Reza FARIVAR, Champaign, IL (US); Austin WALTERS, Savoy, IL (US); Jeremy GOODSITT, Champaign, IL (US)

(73) Assignee: Capital One Services, LLC, McLean, VA (US)

(21) Appl. No.: 17/228,179

(22) Filed: Apr. 12, 2021

(51) Int. Cl. G06Q 30/06; G06F 16/245; G06Q 20/40; G06Q 10/08; G06Q 30/02; G06Q 40/02; G06N 20/00; G06N 5/04

(52) U.S. Cl. CPC G06Q 30/0623; G06F 16/245; G06Q 20/407; G06Q 10/087; G06Q 30/0204; G06Q 40/025; G06N 20/00; G06N 5/04

(57) ABSTRACT

A computer-implemented method for determining a utility life of a target item that includes detecting an acquisition of the target item, and determining one or more prior acquisitions at least partially correspond to the acquisition of the target item. The method further includes determining the utility life of the target item based on the one or more prior acquisitions, and transmitting an alert to a user device with information of the utility life of the target item prior to completion of the acquisition.

### TECHNICAL FIELD

Various embodiments of the present disclosure relate generally to a system for determining a useful life of a target item, and relate particularly to methods and systems for generating alerts with information of the utility life based on prior acquisition data of the user.

### BACKGROUND

Acquisitions (e.g., purchases) of certain products by consumers may require prolonged periods of payment that extend beyond the initial acquisition of the product, such as through a periodic payment plan. Although a practical service life of the product may remain well after payment of the product is complete, various products may have a relatively shorter effective useful life given continuously changing trends, fashions, and market developments. In some instances, given the nature of the product, a useful life of the product may expire prior to the consumer completing payment of the product such that the consumer may be required to continue fulfilling payment obligations for a product that they no longer deem useful. Consumers may develop resentment toward such prior acquisitions and/or elect to forgo continued payments in conflict with their payment obligations.

The present disclosure is directed to addressing one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

According to certain aspects of the disclosure methods, systems, and non-transitory computer-readable media are disclosed for generating alerts with information of a utility life of a target item for consideration by a user prior to the completion of an acquisition. Each of the examples disclosed herein may include one or more of the features described in connection with any of the other disclosed examples.

In one example, a computer-implemented method for determining a utility life of a target item, comprising: detecting an acquisition of the target item; determining one or more prior acquisitions at least partially correspond to the acquisition of the target item; determining the utility life of the target item based on the one or more prior acquisitions; and transmitting an alert to a user device with information of the utility life of the target item prior to completion of the acquisition.

In another example, a computer-implemented method for determining a utility life of a target item, comprising: detecting occurrence of an acquisition for the target item; determining the occurrence of the acquisition is at least a second occurrence of the acquisition for the target item based on a comparison of one or more characteristics of the target item at the second occurrence and a first occurrence of the acquisition; in response to determining the acquisition is at least the second occurrence, determining the utility life of the target item based on a duration between the second occurrence and the first occurrence; and transmitting the utility life of the target item to a user device during the occurrence of the acquisition.

In a further example, a system facilitating calculation of a utility life when acquiring a target item may include a processor, and a memory storing instructions that, when executed by the processor, causes the processor to perform operations including: detecting an acquisition of the target item; determining one or more prior acquisitions at least partially correspond to the acquisition of the target item; determining the utility life of the target item based on the one or more prior acquisitions; and transmitting an alert to a user device with information of the utility life of the target item prior to completion of the acquisition.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary client-server environment that may be utilized according to aspects of the present disclosure.

FIG. 2 depicts an exemplary process for transmitting utility life information to a user device.

FIG. 3 depicts an example of a computing device, according to aspects of the present disclosure.

### DETAILED DESCRIPTION OF EMBODIMENTS

The terminology used in this disclosure is to be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “computer system” generally encompasses any device or combination of devices, each device having at least one processor that executes instructions from a memory medium. Additionally, a computer system may be included as a part of another computer system.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially,” “approximately,” “about,” and “generally,” are used to indicate a possible variation of ±10% of a stated or understood value.

In general, the present disclosure provides methods and systems for generating and transmitting utility life information to a user device based on detecting the occurrence of or the anticipation of an occurrence of an object (e.g., a good, a service, etc.) acquisition and identifying a corresponding object acquisition from prior acquisition data that is similar to the present object acquisition. A utility life of the object targeted for acquisition through the present transaction is determined based on the prior acquisition data, and an alert may be transmitted to the user with information of the utility life. The information may allow a user to identify the utility life of the prospective object and evaluate whether acquisition of the object is desired given the information. For instance, a user may deem the object acquisition to be financially imprudent when determining the utility life of the object is shorter than the payment period for the object. As will be discussed in greater detail herein, existing techniques may be improved with the methods and systems of the present disclosure.

In some instances, information relating to the utility life of an item (e.g., a good, a service, etc.) may be unknown to the user when initially acquiring the item. Furthermore, consumers may mistakenly determine that a utility life of an item is equal to, or synonymous with, a service life of the item, such that the consumer may consider misleading information when deciding whether to conduct the acquisition. Users seeking to minimize instances of purchasing items that the user is likely to cease use of before fulfilling payment obligations for the item (e.g., products or services) may require proactive assistance in identifying the utility life of item during the acquisition process. Accordingly, a need exists to provide a real-time ability to generate and transmit alerts to a user with utility life information when conducting object acquisitions based on prior acquisition data.

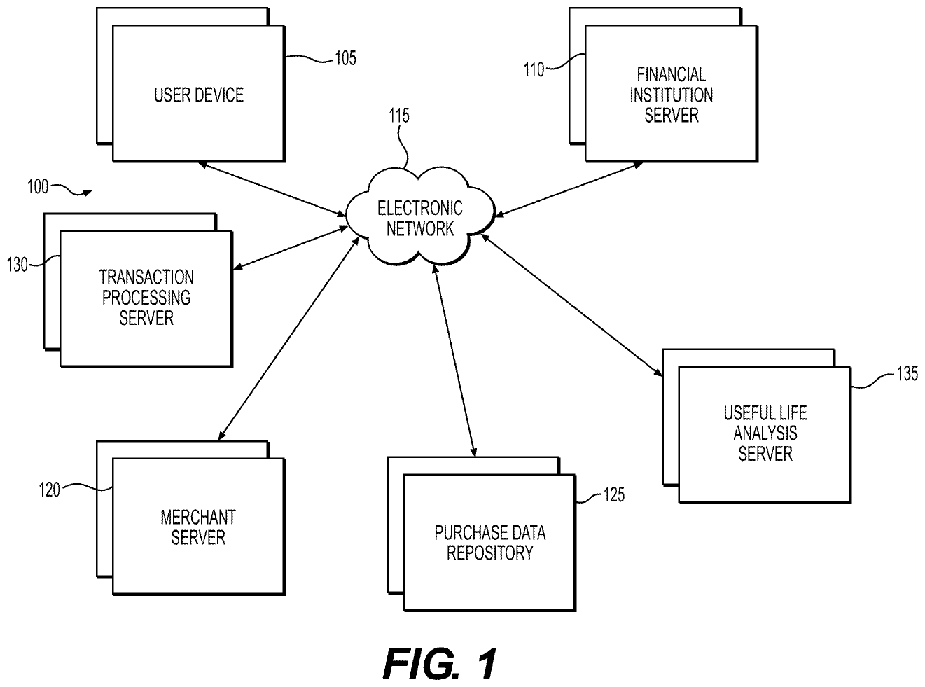

FIG. 1 depicts an exemplary client-server environment that may be utilized with techniques presented herein. For example, the environment may include a system 100 with one or more user devices 105, one or more financial institution servers 110, one or more merchant servers 120, and a purchase data repository 125. System 100 may further include a transaction processing server 130 and a useful life analysis server 135. The one or more components of system 100 may communicate with one another across an electronic network 115, and in any arrangement.

It should be appreciated that system 100 may include a plurality of users, each of which may include or otherwise be associated with at least one user device 105. User device 105 may include various suitable apparatuses, including but not limited to, a mobile device, a computer, a wearable device (e.g., a smartwatch) and the like. User device 105 may be configured to transmit and receive signals between one or more components of system 100, the signals being indicative of a data or messages relating to an object acquisition (e.g., transaction, purchase, etc.). One or more user devices 105 may include a third-party software installed thereon for receiving signals from other components of system 100. The third-party software may include, but is not limited to, an electronic application (e.g., a mobile internet application, a text messaging application, an e-commerce application, a social media application, or the like), an internet browser extension, or a website page. The third-party software on user device 105 may include programmable instructions that cause user device 105 to communicate with the one or more components of system 100.

The user may be a customer of one or more financial institutions and may have one or more consumer accounts with said financial institution(s). In this instance, the one or more consumer accounts may be stored on (or otherwise associated with) financial institution server 110. The user may conduct (or attempt to conduct) one or more transactions with the consumer account(s), such as, for example, purchasing a product, a good, or a service (collectively referred to herein as “item”) from one or more merchants, retailers, and the like. Financial institution server 110 may include or be in communication with a purchase data repository 125 for storing historical financial data, such as, for example, acquisition (purchase) data. In the example, financial institution server 110 is depicted as a separate component from purchase data repository 125, however, in many embodiments, the financial data may be stored on financial institution server 110.

Merchant server 120 may be configured to generate acquisition data indicative of an item acquisition (e.g., purchase) made or initiated with the consumer account. In some embodiments, the consumer account may be communicatively coupled to a consumer card (e.g., credit card, debit card, etc.), a mobile payment application (e.g., on user device 105), and the like. Accordingly, completing a purchase may generate the acquisition data thereby indicating an occurrence of an item acquisition (e.g., transaction). In some embodiments, the acquisition data may include various information relating to the transaction.

For example, the acquisition data may include one or more purchase characteristics (e.g., data fields) relating to the transaction. The one or more purchase characteristics may include, but are not limited to, a product (e.g., good, service, etc.) name, a merchant name, a transaction date, a transaction time, a transaction identification number, a transaction amount, a merchant identification number, a merchant category code, a product description, a transaction description, an image, and more. Merchant server 120 may be configured to communicate the acquisition data to financial institution server 110 and/or purchase data repository 125.

In some embodiments, a user may generate acquisition data relating to the transaction via user device 105. For example, a user may be prompted by transaction processing server 130 to provide information relating to the item acquisition at a time of the transaction. In one example, a user may transmit a picture of the prospective item for acquisition, a label, a price tag, a sign, and/or a receipt documenting details of the item, etc., taken from user device 105 or another device in communication with user device 105. In many embodiments, user device 105 may automatically generate acquisition data relating to the transaction, such as, for example, in the form of metadata. The metadata may include information defining a location of the user at the time of purchase, an identification of the user, and more. Purchase data repository 125 may store the acquisition data generated by merchant server 120 and/or user device 105 and associate the data with the consumer account of the user.

The item acquisitions conducted by a user for various goods or services may be associated with one or more item groupings. The item groupings may include prior acquisition data of one or more prior acquisitions having similar characteristics to one another. In some examples, the one or more prior item acquisitions are grouped together within item groupings based on having a minimum number of similar characteristics that at least exceed a similarity threshold. The prior item acquisition data of the user may be stored in purchase data repository 125 and may be grouped together with the acquisition data of a plurality of users of system 100.

Transaction processing server 130 may be configured to detect an occurrence (or an attempted occurrence) of an item acquisition in response to receiving data corresponding to the item acquisition from one or more components of system 100. For example, transaction processing server 130 may receive acquisition data from financial institution server 110 and/or merchant server 120. Transaction processing server 130 may be further configured to obtain prior item acquisition data from financial institution server 110 and/or purchase data repository 125, and useful life information associated with the item acquisition or prior item acquisitions from useful life analysis server 135.

Useful life analysis server 135 may be configured to train a machine learning model to determine that a detected item acquisition is similar to one or more prior items acquisition conducted by the user or the plurality of users. Useful life analysis server 135 may be further configured to train the machine learning model to determine a useful life of the item being acquired in the detected item acquisition based on prior acquisition data associated with the one or more prior item acquisitions.

As used herein, a “machine learning model” may include data (e.g., acquisition data, utility life data, etc.) or instruction(s) for generating, retrieving, and/or analyzing such data. Further, as used herein, a “machine learning model” is a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

Still referring to FIG. 1, one or more of user device 105, financial institution server 110, merchant server 120, purchase data repository 125, transaction processing server 130, and/or useful life analysis server 135 may communicate with each other over the electronic network 115 in executing the machine learning model to determine a utility life of a target item based on prior acquisition data. Electronic network 115 may include a telecommunications network such that one or more of user device 105, financial institution server 110, merchant server 120, purchase data repository 125, transaction processing server 130, and/or useful life analysis server 135 may communicate with one another over the telecommunications network. The telecommunications network may include, for example, a telephone network, a cellular network, and the like. In many embodiments, electronic network 115 may be a public switched telephone network (PTSN), a voiceover Internet Protocol (VoIP) network, a wide area network (“WAN”), a local area network (“LAN”), personal area network (“PAN”), or the like.

While FIG. 1 depicts the various components of system 100 as physically separate and communicating across network 115, it should be appreciated that in a variety of embodiments one or more components of system 100 may be incorporated partially or completely into any of the other components shown in FIG. 1. Some or all of the functionality of the machine learning model may be incorporated into one or more components of system 100, such as, for example, transaction processing server 130 and/or useful life analysis server 135. Some or all of the functionality of transaction processing server 130 and/or useful life analysis server 135 may be accessible via user device 105 and incorporated into a mobile internet application, an internet browser extension, or website page.

In some embodiments, one or more components of system 100 (e.g., transaction processing server 130, useful life analysis server 135) may be configured to train a machine learning model to execute one or more processes, such as, for example, process 200 shown and described herein. As described in further detail below, useful life analysis server 135 may be further configured to train the machine learning model to predict one or more variables in addition to executing the exemplary process 200. The one or more variables may include a relationship between one or more prior item acquisitions and a recent item acquisition, and more.

Multiple approaches may be used when predicting the relationship between prior item acquisitions and recent item acquisitions. The machine learning model trained by useful life analysis server 135 may include an automatable, adaptable tool that may provide accurate predictions as to the relationship. In some embodiments, the model trained by useful life analysis server 135 may include using a “base” or standard machine learning algorithm or technique, and adapting it based on the acquisition data and/or utility life data received from the one or more components of system 100. In such embodiments, a model including a base machine learning algorithm or technique configured to provide predictions may be trained by useful life analysis server 135. It should be appreciated that useful life analysis server 135 may be one or more hardware and/or software components that are configured to sort and analyze the data shown and described herein, generate, train, and/or modify the machine learning model, predict a relationship between item acquisitions, and determine a recent acquisition is related to a prior acquisition using the trained machine learning models.

In some embodiments, useful life analysis server 135 may include a plurality of computing devices working in concert to perform data analyses and to determine the useful life evaluation. Such computing devices may be any suitable computing devices, now-known or later-developed, capable of performing aspects of the processes and methods described herein. Useful life analysis server 135 may be located in a single geographic area or multiple geographic areas, and may be connected to one another via, e.g., wired or wireless components (e.g., network 115). System 100 may be programmed in various suitable formats, such as, for example, on a platform of a financial institution service provider, a web browser extension, a mobile device application, a payment service provider, and more. It should be appreciated that one or more components of system 100, such as, for example, financial instruction server 110, merchant server 120, purchase data repository 125, transaction processing server 130, and/or useful life analysis server 135 may collectively belong to a common entity.

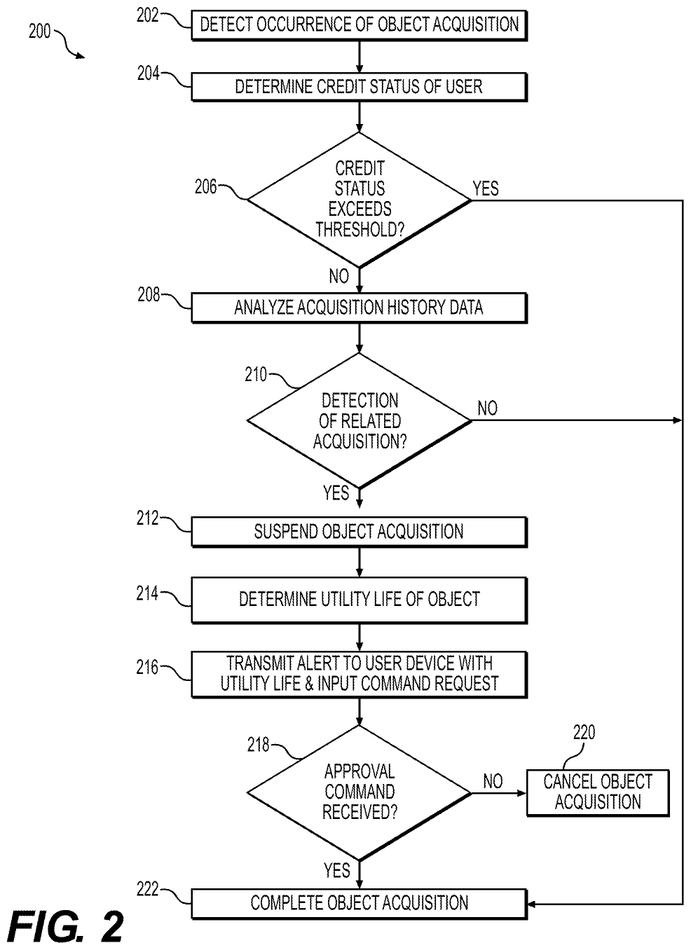

FIG. 2 illustrates an exemplary process 200 for generating an alert with utility life information of a target item for acquisition based on prior acquisition data in accordance with embodiments of the present disclosure. It should be understood that the steps described herein, and the sequence in which they are presented, are merely illustrative such that additional and/or fewer steps may be included without departing from the scope of the present disclosure.

At step 202, transaction processing server 130 (and/or financial institution server 110) may detect an object acquisition, e.g., an occurrence of a pending transaction conducted with a consumer account (hereinafter referred to as “present object acquisition”). For example, initiation of a transaction may be detected by transaction processing server 130 in response to receiving acquisition data indicative of a prospective purchase to be made with the consumer account, such as from merchant server 120. In some embodiments, the consumer account may be communicatively coupled to a consumer card (e.g., credit card, debit card, etc.), a mobile payment application (e.g., on user device 105), and the like. Accordingly, initiating a purchase may generate the acquisition data, thereby indicating an occurrence of the transaction. In some embodiments, the acquisition data may include various information relating to the pending transaction.

For example, the acquisition data may include one or more purchase characteristics (e.g., data fields) relating to the pending transaction. The one or more purchase characteristics may include, but are not limited to, a product (e.g., good, service, etc.) name, a merchant name, a transaction date, a transaction time, a transaction identification number, a transaction amount, a merchant identification number, a merchant category code, a product description, a transaction description, an image, and more.

At step 204, transaction processing server 130 may be configured to determine a credit status of the user initiating the object acquisition. It should be appreciated that the credit status may be indicative of various suitable information, including but not limited to, a user's credit score, payment history with the financial institution service provider, and/or other data indicative of the user's creditworthiness. In the example, transaction processing server 130 may communicate with one or more components of system 100, such as the one or more financial institution servers 110, to obtain credit information associated with the user. It should be understood that the credit information may include a numerical expression or score that is based on an analysis of the user's personal credit files, representing a measured creditworthiness of the user. Transaction processing server 130 may obtain the credit information from financial institution server 110 and determine the credit status of the user based on the credit information. At step 206, transaction processing server 130 may compare the credit status of the user to a predefined threshold.

In response to determining the credit status exceeds the predefined threshold at step 206, transaction processing server 130 may proceed to complete the present object acquisition at step 222. Transaction processing server 130 may determine to allow the object acquisition detected at step 202 to be processed when the user's credit status is greater than a minimum threshold. In this instance, the present object acquisition may be processed and process 200 may be completed.

In many embodiments, the minimum threshold may be defined by financial institution server 110 and/or a user of system 100. In some embodiments, the minimum threshold may be automatically determined by transaction processing server 130, such as, for example, at least partially based on the item being acquired. For example, the minimum threshold may be dynamically adjusted based on the one or more purchase characteristics of the object acquisition.

In many embodiments, a user may selectively activate and/or deactivate execution of steps 204 and 206 of the exemplary process 200, such as, for example, via user device 105. Accordingly, upon deactivation of steps 204 and 206, transaction processing server 130 may be configured to automatically proceed to step 208 upon detecting an occurrence of an object acquisition at step 202. In further embodiments, process 200 may omit steps 204 and 206 entirely.

In response to determining the credit status does not exceed the predefined threshold at step 206, transaction processing server 130 may analyze prior acquisition history data at step 208. Transaction processing server 130 may communicate with financial institution server 110 to retrieve acquisition data of previous object acquisitions conducted by the user and/or a plurality of other users. Transaction processing server 130 may analyze acquisition data of the particular user conducting the present object acquisition detected at step 202; while in many embodiments, transaction processing server 130 may be configured to analyze acquisition data of a plurality of users of system 100.

At step 210, transaction processing server 130 may be configured to determine whether the object acquired in the transaction at step 202 is similar (e.g., related, repeat) to one or more prior object acquisitions. For example, transaction processing server 130 may determine one or more item groupings that include prior object acquisitions that are related to the target item in the present object acquisition.

For example, transaction processing server 130 may be configured to determine an item grouping of the object acquisition detected at step 202 from one of a plurality of item groupings. Each of the plurality of item groupings may include data indicative of a plurality of prior object acquisitions conducted by the user performing the object acquisition at step 202 and/or by a plurality of other users. In some embodiments, the plurality of object groupings, and the corresponding data for each of the plurality of prior object acquisitions categorized within each of the object groupings, may be stored in purchase data repository 125.

Transaction processing server 130 may compare the purchase characteristics of the present object acquisition with purchase characteristics of the prior object acquisitions to determine the particular item grouping that the present object acquisition belongs. For example, transaction processing server 130 may determine that the item grouping having prior object acquisitions with substantially similar purchase characteristics as the present object acquisition is the corresponding item grouping of the present object acquisition. It should be appreciated that prior object acquisitions may be clustered together into similar item groupings based on the type of products that were previously acquired (e.g., cameras, computers, cellular devices, vehicles, audible systems, houseware, kitchenware, furniture, etc.).

In many embodiments, transaction processing server 130 may be configured to analyze the purchase history data (e.g., the plurality of prior object acquisitions) categorized within the particular item grouping of the present object acquisition and identify a matching object acquisition within the item grouping that relates to the present object acquisition. Transaction processing server 130 may search the purchase history data within the item grouping (step 208) to identity a prior object acquisition conducted by the user and/or a plurality of other users for a similar item (e.g., good, service, etc.) as that acquired by the user in the present object acquisition (step 202). It should be appreciated that transaction processing server 130 may determine that an item from a prior object acquisition is similar to the target item that is pending acquisition via the present object acquisition from a comparison of the respective purchase characteristics of each to one another.

An item from a prior object acquisition may be similar to the target item to be acquired in the present object acquisition when one or more of a product name, a merchant name, an acquisition amount, a product description, a transaction description, or more are alike. In some instances, transaction processing server 130 may determine that an item is the same despite being different versions from one another, acquired from different merchants, produced by different manufacturers, having different acquisition amounts, and more. Accordingly, it should be appreciated that a prior object acquisition conducted by the user and/or a plurality of other users may be determined to be related to the present object acquisition despite including varying purchase characteristics.

Accordingly, at step 210, transaction processing server 130 may analyze the acquisition data of the prior object acquisitions in the item grouping to determine whether the purchase characteristics of the present object acquisition matches the purchase characteristics of the prior object acquisitions. In some embodiments, transaction processing server 130 may be configured to determine that the present object acquisition matches one or more of the prior object acquisitions when the prior object acquisition includes purchase characteristics that exceed a similarity threshold (e.g., at least one) with the purchase characteristics of the present object acquisition.

By way of illustrative example, the item acquired at step 202 may include an electronic consumer device such that the purchase characteristics of the acquisition data relating to the transaction may identify the item as such. In this instance, a merchant name associated with the object acquisition may identify an electronic appliance retailer at which the electronic consumer device is being purchased. A merchant identification number associated with the electronic appliance retailer from which the item is being acquired, and/or a merchant category code classifying the type of business of which the merchant is a part of, may be indicative of a store primarily engaged in retailing consumer electronic appliances. A product and/or a transaction description may further define the type of good to which the object acquisition relates. A transaction amount associated with the object acquisition may fall within one of a plurality of predefined threshold ranges (e.g., about $1.00 to $100.00, about $101.00 to $200.00, about $201.00 to $500.00, and more), such as about $1.00 to $100.00. It should be appreciated that each of the purchase characteristics may be indicative of the item (e.g., good or service) acquired by the user at step 202 and may serve as a parameter for transaction processing server 130 to determine whether the object acquisition is similar to one or more prior object acquisitions.

In response to transaction processing server 130 not identifying a prior object acquisition related to the present object acquisition at step 210, transaction processing server 130 may proceed to complete the present object acquisition at step 222. Transaction processing server 130 may determine to allow the object acquisition detected at step 202 to be processed when financial institution server 110 and/or purchase data repository 125 do not include acquisition data indicative of similar prior acquisitions. In this instance, the present object acquisition (detected at step 202) may be processed and process 200 may be completed. In response to transaction processing server 130 identifying a prior object acquisition related to the present object acquisition at step 210, transaction processing server 130 may temporarily suspend the present object acquisition from processing at step 212.

At step 214, transaction processing server 130 may direct useful life analysis server 135 to cross-reference the prior object acquisitions having similar purchase characteristics as the present object acquisition to one another and the present object acquisition to determine a utility life of the target item (e.g., the good or service acquired by the user at step 202). Useful life analysis server 135 may determine the utility of the target item to be acquired in the present objection acquisition using a trained machine learning model. For example, useful life analysis server 135 may be configured to train the machine learning model to determine the utility life of the target item based on the prior acquisition data associated with the related prior object acquisitions conducted by the user and/or a plurality of other users conducting the present object acquisition and/or a plurality of other users.

In one example, useful life analysis server 135 trains the machine learning model to calculate an elapsed duration between the one or more prior object acquisitions relative to one another and/or the present object acquisition. The elapsed duration between each of the one or more prior object acquisitions and the present object acquisition may vary relative to one another. Useful life analysis server 135 may train the machine learning model to determine a pattern associated with the elapsed durations and/or one or more parameters that may influence the elapsed durations (e.g., a frequency, a timing, and/or a cost of the object acquisitions) when determining the utility life of the target item. It should be appreciated that transaction processing server 130 may train the machine learning model based on acquisition data (e.g., from purchase data repository 125) of the user or a plurality of users.

In some embodiments, useful life analysis server 135 may train the machine learning model to determine the utility life of the target item based on third-party data, such as, for example, information associated with industry market trends relating to the target item(s), journalistic news of further developments of the target item(s), public service announcements by retailers and/or manufacturers of the target item(s), and more. For example, useful life analysis server 135 may determine that the user routinely acquires items having similar purchase characteristics as prior object acquisitions every 3.5 years during the winter season months of the calendar year, in conjunction with advertised releases of new versions of the target item by the manufacturer, such that the machine learning model may be trained to determine the utility life of the target item accordingly.

In another example, useful life analysis server 135 may train the machine learning model to calculate a payment completion duration of the one or more prior object acquisitions, and/or a payment satisfaction rate for the one or more prior object acquisitions. The payment completion duration and/or payment satisfaction rate for each of the one or more prior object acquisitions may vary relative to one another. Useful life analysis server 135 may train the machine learning model to determine a pattern associated with the payment completion durations (e.g., early, on time, late, etc.) and/or payment satisfaction rates (e.g., satisfied, unsatisfied, etc.), and/or one or more parameters that may influence the payment completion durations and/or payment satisfaction rates (e.g., minimum premium payment amounts, interest rates, and/or costs of the object acquisitions), when determining the utility life of the target item.

Still referring to FIG. 2, useful life analysis server 135 may be configured to determine the utility life of the target item based on one or more of the elapsed duration, payment satisfaction rate, and/or payment completion duration. In embodiments where the prior acquisition data used to determine the utility life is that of the user conducting the present object acquisition, the utility life may include an estimated use duration of the target item and/or a projected exhaustion deadline of the target item. For example, useful life analysis server 135 may determine the estimated use duration of the target item based on, for example, the calculated elapsed durations. Useful analysis server 135 may further determine the projected exhaustion deadline of the target item based on, for example, the estimated use duration and the date of occurrence of the present object acquisition (step 202). It should be appreciated that useful life analysis server 135 may be configured to train the machine learning model to determine the utility life (e.g., the estimated use duration and/or projected exhaustion deadline) of the target item based on data specific to the user conducting the present object acquisition. In this instance, the utility life includes an estimated measurement unique to the user.

In many embodiments, wherein the prior acquisition data used to determine the utility life is from a plurality of other users, the utility life may include an estimated prominence duration of the target item and/or a projected trend deadline of the target item. In this instance, useful life analysis server 135 may be configured to train the machine learning model to determine the utility life (e.g., the estimated prominence duration and/or projected trend deadline) of the target item based on data specific to a plurality of users other than the user conducting the present object acquisition. In this instance, the utility life includes an estimated measurement that is not specific or unique to the user.

By way of illustrative example where the target item includes an electronic audio device, useful life analysis server 135 may determine that the elapsed duration between the present object acquisition (for the electronic audio device) and a first prior acquisition for a similar electronic audio device is about 3.5 years, while the elapsed duration between the first prior acquisition and a second prior acquisition for a similar electronic audio device is about 5.1 years. Useful life analysis server 135 may further determine various other parameters, such as a cost of the electronic audio devices in each of the object acquisitions, a timing of the object acquisitions for the electronic audio devices relative to one another, and/or a minimum premium payment amount required by the respective merchants for the electronic audio devices in each of the object acquisitions. Accordingly, useful life analysis server 135 may use the trained machine learning model to calculate the utility life of the target item, including but not limited to, an estimated use duration and a projected exhaustion deadline of the target item.

At step 216, transaction processing server 130 may generate an alert for transmission to user device 105 (e.g., via electronic network 115) with information of the utility life of the target item. The alert may include an identification of the prior object acquisition(s) that corresponds to the present object acquisition, along with details relating to the status of payment obligation for the prior object acquisitions (e.g., pending, completed, overdue, defaulted, etc.). For example, the status details of payment obligations of a plurality of other users may be categorized and/or quantified (e.g., averaged) for use by the user. In some embodiments, the alert may further include a message requesting an input command from the user. In this instance, the message may solicit the user's confirmatory feedback on whether to process the present object acquisition in light of the utility life information transmitted to the user.

The alert may include a message suggesting reconsideration of completing the object acquisition given the calculated utility life of the target item relative to the calculated payment completion duration and/or payment satisfaction rate. The alert may further include supplemental data for use by the user, such as statistical information relating to a percentage of likelihood for the user conducting a future object acquisition for a target item that is related to the target item of the present object acquisition prior to completion of the utility life and/or payment completion duration of the present objection acquisition. Transaction processing server 130 may transmit the alert to user device 105 via electronic network 115 at step 216, and user device 105 may transmit an input command (e.g., an affirmative or negative response) to transaction processing server 130 responsive to the inquiry.

In response to transaction processing server 130 receiving an input command from user device 105 indicative of a negative response to the inquiry at step 218, transaction processing server 130 may be configured to cancel the present object acquisition at step 220. In this instance, the suspended transaction between the consumer and the merchant is terminated. Alternatively, in response to transaction processing server 130 receiving an input command from user device 105 indicative of an affirmative response (e.g., approval command) to the inquiry at step 218, transaction processing server 130 may be configured to authorize and/or complete the present object acquisition at step 220. In this instance, the suspended transaction is allowed to complete processing, thereby concluding the transaction between the consumer and merchant.

It should be appreciated that system 100 may be configured to generate data (e.g., coverage information) for transmission to a user, wherein the data may not have been previously known to the user. In this instance, system 100 may provide the user with new information, and facilitate suspension of the present object acquisition as the user utilizes said information. Such information may include, but is not limited to, the acquisition data of prior object acquisitions, the utility life of the target item of the present object acquisition, statistical information relating to a likelihood for future object acquisitions related to the present object acquisition occurring prior to the completion of the utility life and/or payment completion duration of the present objection acquisition, and more. System 100 may allow for expedited processing control of the present object acquisition between the user and the merchant. System 100 may decrease a volume of object acquisitions conducted by consumers with merchants in light of the utility life determination transmitted to user devices 105 during a pendency of present object acquisitions. Further, by at least temporarily suspending the present object acquisition to facilitate transmission of the utility life information to user device 105, system 100 may decrease a percentage of item return transactions, thereby minimizing costs associated with processing returns of previously acquired items for the consumer, financial institutions, and/or merchant servers.

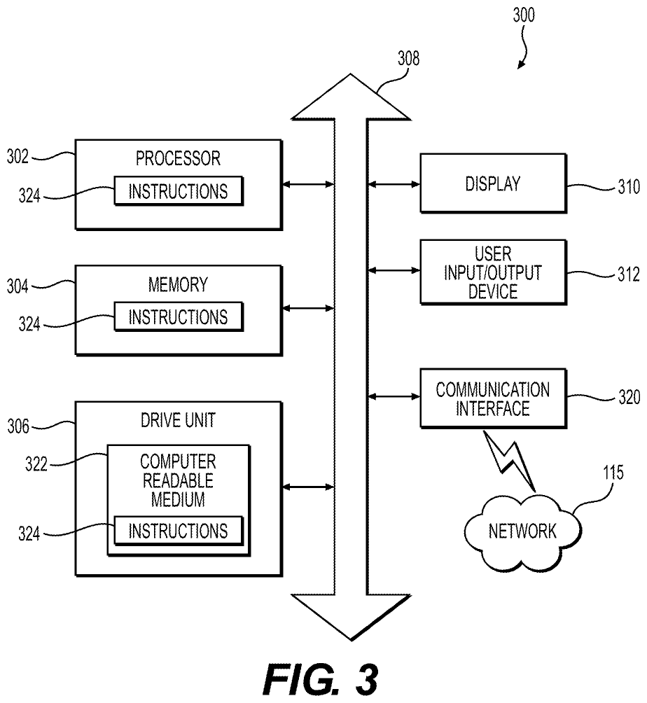

FIG. 3 is a simplified functional block diagram of a computing device 300 that may be configured as a device for executing the methods of FIG. 2, according to exemplary embodiments of the present disclosure. Any of the devices, databases (e.g., servers), processors, etc. of system 100 discussed herein may be an assembly of the hardware of computing device 300 including, for example, user device 105, financial institution server 110, merchant server 120, purchase data repository 125, transaction processing server 130, and/or useful life analysis server 135, according to exemplary embodiments of the present disclosure.

Computing device 300 may include a central processing unit (“CPU”) 302 that may be in the form of one or more processors configured to execute program instructions, such as those of process 200 described in detail above. In some embodiments, the processor(s) of CPU 302 includes both a CPU and a GPU. Computing device 300 may further include a storage unit 306 that may include non-volatile memory, such as, for example, a storage media (e.g., solid-state drives), ROM, HDD, SDD, etc. Examples of storage media include solid-state storage media (e.g., solid state drives and/or removable flash memory), optical storage media (e.g., optical discs), and/or magnetic storage media (e.g., hard disk drives). Storage unit 306 may store data on a computer readable medium 322. In some embodiments, computing device 300 may receive programming and data via network communications from electronic network 115, such as, for example, via a communication interface 320 configured to communicate with one or more other components of system 100.

Still referring to FIG. 3, computing device 300 may include a memory 304 that is volatile memory, such as, for example, RAM, solid-state memories, optical storage media (e.g., optical discs), magnetic storage media (e.g., hard disk drives), etc. Memory 304 may be configured for storing one or more instructions 324 for executing techniques presented herein, such as those of process 200 shown and described above. Memory 304 may further include a non-transitory computer-readable medium. Therefore, whenever a computer-implemented method is described in this disclosure, this disclosure shall also be understood as describing a non-transitory computer-readable medium storing instructions that, when executed by one or more processors (e.g., CPU 302), cause the one or more processors to perform the computer-implemented method.

In some embodiments, the one or more instructions 324 may be stored temporarily or permanently within other modules of computing device 300, such as, for example, CPU 302, computer readable medium 322, and more. Computing device 300 may include an input/output device 312 including one or more input ports and one or more output ports. Input/output device 312 may include, for example, a keyboard, a mouse, a touchscreen, etc. (i.e., input ports). Input/output device 312 may further include a monitor, a display, a printer, etc. (i.e. output ports). Computing device 300 may further include a display device 310 configured to connect with input/output device 312. The aforementioned elements of computing device 300 may be connected to one another through an internal communication bus 308, which represents one or more busses.

In many embodiments, the various system functions of process 200 shown in FIG. 2 may be implemented in a distributed fashion on a number of similar platforms to distribute the processing load on multiple computing devices 300. Alternatively, the system functions may be implemented by appropriate programming of one computer hardware platform, such as, for example, computing device 300.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming.

All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed methods, devices, and systems are described with exemplary reference to transmitting data, it should be appreciated that the presently disclosed embodiments may be applicable to any environment, such as a desktop or laptop computer. Also, the presently disclosed embodiments may be applicable to any type of Internet protocol. It is intended that the specification and examples be considered as exemplary only, with a true scope and spirit of the disclosure being indicated by the following claims.

In general, any process discussed in this disclosure that is understood to be performable by a computer may be performed by one or more processors. Such processes include, but are not limited to, the process shown in FIG. 2, and the associated language of the specification. The one or more processors may be configured to perform such processes by having access to instructions (computer-readable code) that, when executed by the one or more processors, cause the one or more processors to perform the processes. The one or more processors may be part of a computer system (e.g., one of the computer systems discussed above) that further includes a memory storing the instructions. The instructions also may be stored on a non-transitory computer-readable medium. The non-transitory computer-readable medium may be separate from any processor. Examples of non-transitory computer-readable media include solid-state memories, optical media, and magnetic media.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in many embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above-disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for determining a utility life of a target item, the method comprising:
detecting an acquisition of the target item;
determining one or more prior acquisitions at least partially correspond to the acquisition of the target item;
determining the utility life of the target item based on the one or more prior acquisitions; and
transmitting an alert to a user device with information of the utility life of the target item prior to completion of the acquisition.

2. The computer-implemented method of claim 1, wherein prior to determining the utility life of the target item, the method comprises:
suspending completion of the acquisition; and
transmitting an inquiry message to the user device for processing the acquisition, wherein completion of the acquisition is suspended until an input responsive to the inquiry message is received from the user device.

3. The computer-implemented method of claim 2, further comprising:
receiving the input from the user device in response to the inquiry message;
when the response to the input includes a cancellation command, terminating the acquisition; and
when the response to the input includes an approval command, authorizing the acquisition.

4. The computer-implemented method of claim 1, wherein determining one or more prior acquisitions at least partially correspond to the acquisition of the target item comprises:
determining a grouping of the acquisition from a plurality of groupings;
identifying the one or more prior acquisitions within the same grouping as the acquisition; and
determining the one or more acquisitions are associated with at least one prior target item that is related to the target item.

5. The computer-implemented method of claim 4, wherein each of the plurality of groupings includes data indicative of a plurality of prior acquisitions having one or more characteristics that are related to one another.

6. The computer-implemented method of claim 5, wherein determining the grouping of the acquisition from the plurality of groupings comprises:
comparing the one or more characteristics of the acquisition to the one or more characteristics of the plurality of prior acquisitions grouped in each of the plurality of groupings.

7. The computer-implemented method of claim 6, wherein determining the grouping of the acquisition from the plurality of groupings further comprises:
determining at least one grouping from the plurality of groupings that includes the one or more prior acquisitions having characteristics that exceed a similarity threshold with the characteristics of the acquisition.

8. The computer-implemented method of claim 7, wherein the characteristics includes a product name, a product description, a merchant name, a merchant category code associated with the acquisition, or an acquisition amount.

9. The computer-implemented method of claim 5, wherein the plurality of prior acquisitions includes acquisitions conducted by a user conducting the acquisition of the target item and a plurality of users conducting acquisitions for prior target items.

10. The computer-implemented method of claim 9, wherein the utility life includes an estimated use duration of the target item based on acquisitions conducted by the user, such that the alert includes information of a projected exhaustion deadline of the target item that is specific to the user conducting the acquisition of the target item.

11. The computer-implemented method of claim 9, wherein the utility life includes an estimated prominence duration of the target item based on acquisitions conducted by the plurality of users, such that the alert includes information of a projected trend deadline of the target item that is specific to the plurality of users conducting acquisitions of the prior target items.

12. The computer-implemented method of claim 1, wherein determining the utility life of the target item comprises:
calculating a duration between the acquisition of the target item and at least one of the one or more prior acquisitions.

13. The computer-implemented method of claim 1, wherein prior to determining the one or more prior acquisitions at least partially correspond to the acquisition of the target item, the method comprises:
determining a credit rating of a user conducting the acquisition;
ceasing determination of whether the one or more prior acquisitions at least partially correspond to the acquisition when the credit rating exceeds a threshold; and
conducting determination of whether the one or more prior acquisitions at least partially correspond to the acquisition when the credit rating is below the threshold.

14. A computer-implemented method for determining a utility life of a target item, the method comprising:
detecting occurrence of an acquisition for the target item;
determining the acquisition for the target item is at least a second occurrence of the acquisition;
in response to determining the acquisition for the target item is at least the second occurrence of the acquisition, determining the utility life of the target item based at least partially on a duration between the second occurrence of the acquisition and a first occurrence of the acquisition; and
transmitting the utility life of the target item to a user device during the second occurrence of the acquisition.

15. The computer-implemented method of claim 14, wherein prior to determining the utility life of the target item, the method comprises:
suspending completion of the acquisition;
transmitting a command request to the user device for processing the acquisition;
when an input to the command request includes a cancellation command from the user device, terminating the acquisition; and
when the input to the command request includes an approval command from the user device, authorizing the acquisition.

16. The computer-implemented method of claim 14, wherein determining the utility life of the target item comprises:
determining a duration between occurrences of a plurality of acquisitions for target items related to the target item of the acquisition at the second occurrence; and
determining the utility life of the target item based on the duration between the plurality of acquisitions for the target items.

17. The computer-implemented method of claim 14, wherein determining the acquisition is at least the second occurrence of the acquisition comprises:
comparing characteristics of the acquisition at the second occurrence to characteristics of a plurality of prior acquisitions grouped in each of a plurality of categories;
assigning the acquisition to at least one category of the plurality of categories based on the characteristics of the acquisition matching characteristics of the plurality of prior acquisitions grouped in the at least one category; and
determining at least one of the plurality of prior acquisitions in the at least one category includes the first occurrence of the acquisition, wherein the characteristics of the acquisition at the first occurrence exceeds a similarity threshold with the characteristics of the acquisition at the second occurrence.

18. The computer-implemented method of claim 14, wherein the utility life includes an estimated prominence duration of the target item, and the method further comprises:
transmitting information of a projected trend deadline of the target item to the user device.

19. The computer-implemented method of claim 14, wherein the utility life includes an estimated service duration of the target item, and the method further comprises:
transmitting information of a projected exhaustion deadline of the target item to the user device.

20. A system for facilitating calculation of a utility life when acquiring a target item, comprising:
a processor; and
a memory storing instructions that, when executed by the processor, causes the processor to perform operations including:
detecting an acquisition of the target item;
determining one or more prior acquisitions at least partially correspond to the acquisition of the target item;
determining the utility life of the target item based on the one or more prior acquisitions; and
transmitting an alert to a user device with information of the utility life of the target item prior to completion of the acquisition.
